(19) United States
(12) Patent Application Publication
(10) Pub. No.: US 2020/0223165 A1
(43) Pub. Date: Jul. 16, 2020

(54) Vulcanized Inflatable Product Comprising Spacing Fabric

(71) Applicant: Gumotex, Akciova Spolecnost, Breclav (CZ)

(72) Inventors: Libor Vitek, Postorna (CZ); Patrik Stastny, Hodonin (CZ); Katerina Novakova, Vracov (CZ); Veronika Prochazkova, Vnorovy (CZ)

(21) Appl. No.: 16/647,743

(22) PCT Filed: Sep. 18, 2018
(86) PCT No.: PCT/CZ2018/050049

§ 371 Date: Mar. 16, 2020

(30) Foreign Application Priority Data
Sep. 18, 2017 (CZ) PV2017-555

(51) Int. Cl. B29D 22/02; B32B 1/00; B32B 5/04; B32B 5/12; B32B 5/02

(52) U.S. Cl. CPC B29D 22/02; B32B 2553/00; B32B 5/04; B32B 5/12; B32B 5/026; B32B 2255/02; B32B 2255/04; B32B 2255/10; B32B 2255/26; B32B 2255/28; B32B 2260/021; B32B 2260/046; B32B 2262/0238; B32B 2262/0253; B32B 1/00

(57) ABSTRACT

Vulcanized inflatable product comprising an impervious shell which forms the wall of at least one inflatable chamber (1) and which is provided with a valve (2) for inflating and deflating the inflatable product, at least one spacing fabric (41) being arranged inside the inflatable chamber (1), said spacing fabric comprising a first fabric layer (44) and a second fabric layer (45) mutually tied up by means of interconnecting threads (46) for delimiting the maximum distance therebetween, the first fabric layer (44) of the spacing fabric being directly or indirectly secured to one of the inner walls of the outer shell (5) of the inflatable chamber by means of a vulcanized rubber mixture and the other fabric layer (45) of the spacing fabric being directly or indirectly secured to the opposite inner wall of the outer shell (5) of the inflatable chamber by means of a vulcanized rubber mixture.

### FIELD OF THE INVENTION

The present invention relates to a vulcanized inflatable product comprising a spacing fabric, the latter being provided with a paint and/or coating applied to the two opposing outer sides thereof.

### BACKGROUND OF THE INVENTION

At the present time, an inflatable product, which is composed of an outer shell and as inflatable chamber, is generally known in the field of vulcanized inflatable products. The outer shell of said product comprises a carrying fabric provided with a layer of a rubber mixture applied thereto. The inflatable chamber, which is subdivided into individual spatial portions by means of internal partitions (I-beams), is provided by a single glued joint extending along the circumference of the chamber. The shape of the inflated product is influenced by the basic height or travel range of the internal partitions (I-beams) as well as the by layout thereof. Nevertheless, even if the internal partitions are arranged as close to each other as possible, a planar shape of the inflated product cannot be obtained.

The known inflatable products, which comprise a spacing fabric, are characterized in that the spacing fabric consists of top and bottom fabric layers provided with an impermeable coating and/or paint composed of a PVC or PUR foil, a rubber mixture or a similar coating material. The fabric layers of the spacing fabric are mutually joined by means of hair-like velour threads. The lengths of the threads determine the maximum spacing of the fabric layers.

After having been treated in a manner like that, the material can be used for preparing half-finished products (mostly by cutting), the latter having shapes defining the desired spatial arrangement of the inflatable chamber. In order to enable the products to be sealed off and to ensure the airtightness of the same, the main layers, which are arranged along the circumference of the inflatable chamber, are provided by a sealing ribbon glue affixed thereto by glueing or welding. The products are provided with inflation/deflation valves arranged within one of the main layers or within a peripheral ribbon. The individual inflatable chamber can be assembled by means of additional “cut-outs” made of carrying fabric provided with coating and/or paint layers applied to either side thereof, said assembling process involving glueing and/or welding and enabling inflatable final products to be obtained, such as inflatable boats and the like (US2017008602, US2016096591) or inflatable camp beds, mattresses, pontoons, paddle boards and the like (US2016369431, US2014080369). According to the intended use, the products can be fitted with additional elements, such as various handles or fixtures. In order to obtain large contact surface areas, the semi-finished products, which are provided with cut-outs as described above, can be “butted” and, again, the peripheral area thereof can be sealed by means of a ribbon. An adequate level of protection of the products can be achieved by providing the same with additional protective layers, preferably with an anti-slip coating (e.g. on the basis of an EVA foam or PVC foil).

One of the drawbacks of the above mentioned technical solutions consists in the low productivity of the respective glueing or welding process used for sealing off the product by means of a peripheral ribbon, as well as in a poor resistance against mechanical damage. This is due to the fact that the airtightness of the product depends on the integrity of the outermost layer (i.e., on the properties of the coating and/or paint layer). In order to ensure an increased mechanical resistance, a higher value of the square weight of the outer coating/paint is selected or some additional protective layers are applied which, however, results in poor capability and excessive overall weight of the products. Besides that, two individual joints are created when the product is sealed off by means of a glued or welded ribbon, which results in a twofold potential risk of product failure.

### SUMMARY OF THE INVENTION

The above mentioned drawbacks of the prior art are largely eliminated by the vulcanized inflatable product having the features as defined in claim 1.

According to the present invention, a vulcanized inflatable product comprising an impervious shell which forms the wall of at least one inflatable chamber and which is provided with a valve for inflating and deflating the inflatable product, the subject matter of the invention consisting in that at least one spacing fabric is arranged inside the inflatable chamber, said spacing fabric comprising a first fabric layer and a second fabric layer mutually tied up by means of interconnecting threads for delimiting the maximum distance therebetween, the first fabric layer of the spacing fabric being directly or indirectly secured to one of the inner walls of the outer shell of the inflatable chamber by means of a vulcanized rubber mixture and the other fabric layer of the spacing fabric being directly or indirectly secured to the opposite inner wall of the outer shell of the inflatable chamber by means of a vulcanized rubber mixture. The term “interconnecting thread” refers to a textile thread of fibre or to a yarn made of textile fibres.

In an advantageous embodiment of the invention, the inflatable product further comprises auxiliary threads for delimiting the maximum mutual distance between the first fabric layer and the second fabric layer of the spacing fabric prior to the initial inflation of the inflatable product according to the invention. The employment of the auxiliary threads facilitates handling of the inflatable product during the manufacturing process or, as the case may be, prior to the initial inflation. The selected strength and/or arrangement of the auxiliary threads should ensure that such threads break and/or get loose from one or the other fabric layer and/or detach from each other, thereby making it possible that the respective fabric layers are drawn apart, the final mutual distance of the latter being delimited by the length of the connecting threads. Hence, the first fabric layer and the second fabric layer are mutually tied up by means of auxiliary threads for fixing the fabric layers in a mutual position, in which the latter adjoin each other, prior to the initial inflation of the product.

In an advantageous embodiment of the inflatable product according to invention, the fabric layers of the spacing fabric are secured to the walls of the inflatable chamber in an area-wide manner.

In another advantageous embodiment of the inflatable product according to the invention, the outer shell of the inflatable chamber comprises at least one carrying fabric, said carrying fabric and the fabric layers of the spacing fabric being embedded, in a mutually adjacent arrangement, inside a common layer composed of a vulcanized rubber mixture.

In yet another advantageous embodiment of the inflatable product according to the invention, the outer shell of the inflatable chamber comprises a first portion and a second portion, which extend beyond the spacing fabric along the circumference thereof, thus enabling a common circumferential joint composed of a vulcanized rubber mixture to be formed between said portions for creating the inflatable chamber.

In a further advantageous embodiment of the inflatable product according to the invention, the carrying fabric is provided with a paint and/or coating applied to the outer side thereof, said paint and/or coating being composed of a material selected from the group comprising a vulcanized rubber mixture, polyurethane or polyvinyl chloride.

In a yet further advantageous embodiment of the inflatable product according to the invention, the carrying fabric of the outer shell is selected from the group comprising a polyester fabric, a cotton fabric, a viscose fabric, a polyamide fabric, a polypropylene fabric or any combination thereof.

Another advantageous embodiment of the inflatable product according to the invention consists in that the inflatable chamber comprises at least one fabric partition, the latter being joined with the outer shell by means of a vulcanized rubber mixture.

A still further advantageous embodiment of the inflatable product according to the invention consists in that the joint, which is formed between the first portion and the second portion, is at least partly covered by an internal connecting ribbon that is arranged inside the inflatable chamber and secured to the outer shell by means of a vulcanized rubber mixture.

The connecting ribbon can be made of a suitable fabric, said fabric being provided with a coating and/or paint composed of a rubber mixture and applied to the contact face of the fabric. The contact face of the fabric ribbon is understood to be that portion of the surface of the ribbon by means of which the latter adjoins the coating and/or paint resting on the inner side of the outer shell of the inflatable chamber. A resilient joint between the contact face of the fabric and the respective wall of the outer shell is formed by vulcanizing the coating and/or paint composed of a rubber mixture.

Another advantageous embodiment of the inflatable product according to the invention consists in that the inflatable product comprises a set composed of at least two inflatable chambers, the circumferential areas of the outer shells of individual chambers being partly interconnected by means of a vulcanized rubber mixture.

In yet another advantageous embodiment of the inflatable product according to the invention, the joint formed between the first portion and the second portion of one inflatable chamber and the joint formed between the first portion and the second portion of the other inflatable chamber adjoining the first inflatable chamber are incorporated in the interconnecting area of said mutually adjoining inflatable chambers.

According to an embodiment of the present invention, the fabric layers constituting the walls of the spacing fabric and the inner walls of the outer shell of the inflatable chamber are provided with at least one coating and/or at least one paint applied thereto. The above mentioned coating and/or paint is composed of a layer of a vulcanizable mixture, the coating resting on the paint and the latter adjoining the fabric. The paint can also impregnate some absorbent fabrics. The fabric walls of the spacing fabric as well as the inner walls of the outer shell of the inflatable chambers are preferably provided both with a coating layer and with a paint layer. In addition, the paint can enhance the adhesion between the underlying coating and the respective fabric, particularly between the coating and the fibres of a synthetic fabric. When natural fabrics are used, the paint can be omitted without compromising the adhesion. In contrast to that, the main beneficial effect of a coating consist in the possibility of applying a single, thicker layer composed of a rubber mixture in a single pass. This means that such a single coating layer can be uses instead of multiple paint layers.

In most cases, the chemical compositions of the chemical mixtures used for the paint and for the coating are identical within the framework of a single product according to the invention. The difference between the properties of the chemical mixtures used for the paint and for the coating consist primarily in the viscosities of the same.

The rubber mixtures applied to the fabrics are based on natural rubbers (NR), synthetic rubbers or suitable combinations thereof. Synthetic rubber can be selected from an extensive group, particularly from that comprising styrene-butadiene rubber (SBR), butadiene rubber (BR), ethylene propylene diene monomer (M-class) rubber (EPDM), chloroprene rubber (CR), nitrile-butadiene rubber (NBR), hydrogenated nitrile butadiene rubber (HNBR), carboxylated nitrile butadiene rubber (XNBR), isobutylene-isoprene rubber (IIR), chlorosulfonated polyethylene synthetic rubber (CSM), ethylene-vinyl acetate copolymer rubber (EVM, EVA) and the like. According to the nature of the rubber or the combination of rubbers used, a vulcanizing agent can be admixed, said agent being selected from the group comprising sulphur, peroxides, metal oxides or reactive resins. Furthermore, the rubber mixture can contain suitable activators, such as those selected, for a sulphur-based system, from the group comprising ZnO or stearin. The mixture may also contain accelerators selected from the group comprising mercaptides, sulphonamides, sulphenimides, thiurams, dithiocarbamates, guanidines and mixtures thereof. The fillers admixed to the rubber mixtures are preferably selected from the group comprising silica (SiO₂), kaolin, CaCO₃ and, as the case may be, carbon black. Besides that, antidegradants (antioxidants) can be admixed, such as those selected from the group comprising phenylenediamines, phenols and benzoimidazols. Additional plasticizers and process admixtures can be selected from the group comprising the derivatives of petroleum products or resins.

The basis of a rubber mixture is always constituted by 100 parts rubber (one or multiple rubber types). When a rubber material containing additional fillers is used, the respective dosage must be adjusted in order to obtain a mixture based on 100 parts of rubber. In the industrial field of rubber mixtures, the concentration of admixtures is usually referred to as phr (parts per hundred rubber). According to one of the embodiments of the present invention, the rubber mixture contains a vulcanising agent selected from the respective group mentioned above in an amount between 0.1 and 7 phr, preferably between 0.5 and 4 phr, and an activator selected from the respective group mentioned above in a amount between 0.5 and 8 phr, preferably between 1 and 5 phr. In addition, the latter mixture contains an accelerator selected from the respective group mentioned above in an amount between 0.5 and 5 phr, preferably between 1 and 5 phr. Furthermore, the rubber mixture may contain and antidegradant selected from the respective group mentioned above in an amount between 1 and 4 phr, preferably between 1 and 3 phr. The rubber mixture may also contain a filler selected from the respective group mentioned above in an amount between 0.1 and 100 phr and a plasticizer selected from the respective group mentioned above in an amount between 0.1 and 100 phr.

Preferably, each of the fabric layer of the spacing fabric contained inside the inflatable product according to the invention is provided with a paint and/or coating composed of a rubber mixture. In the case that the inflatable chamber of the product according to the invention contain just a single spacing fabric, the fabric layers of the latter are directly attached to the walls of the outer shell by means of a vulcanized rubber mixture. The inflatable chamber of the product according to the invention can also comprise multiple spacing fabrics stacked on the top of each other. If the spacing fabrics are stacked on the top of each other, each of them has its first fabric layer attached to one wall of the inflatable chamber in a direct manner and its second fabric layer attached to the other wall of the inflatable chamber in an indirect manner, i.e. by means of the other respective complementary spacing fabric. When multiple spacing fabrics are stacked on top of each other, those spacing fabrics, which have one of their fabric layers directly attached to the shell of the chamber, encompass at least one additional layer interposed therebetween, the latter having its fabric layers indirectly attached to the wall of the outer shell.

The vulcanized inflatable product according to the invention comprises an inflatable chamber with a spacing fabric arranged therein, the dimensions and the shape of said spacing fabric at least partly defining the dimensions and the shape of the inflatable product. The spacing fabric does not need to cover the entire surface area of the inflatable chamber. The free inner space of the inflatable chamber can be provided with internal partitions composed of a fabric having a suitable extent in height, each contact end of the individual fabric partitions being provided with a coating and/or paint composed of a rubber mixture. The contact end of the fabric partition is understood to be that portion of the surface of the partition by means of which the latter adjoins the coating and/or paint resting on the inner side of the outer shell of the inflatable chamber. The inner side of the outer shell is preferably provided with a separator, the latter being applied to that area of the shell where no spacing fabric adjoins. For this purpose, any suitable substance providing a separation effect can be used. The separator can be selected from the group comprising CaCO₃, starches, talc, polyvinyl alcohol, polypropylene (PP), e.g. in the form of a non-woven fabric, polyethylene (PE), e.g. in the form of a non-woven fabric, or polyester (PET), e.g. in the form of a foil. CaCO₃, starches and talc are applied by coating a thin powder layer. Polyvinyl alcohol, which is present in solvents, is applied by spraying or painting, preferably in the form of a thin layer, as well. Non-woven fabric on the basis of PP or PE as well as PET foils are interposed between the individual layers to be separated from each other.

Another advantageous embodiment of the inflatable product according to the present invention consists in that the inflatable product further comprises a separator for preventing the coatings from being mutually joined in at least one area, said separator being arranged between the coatings facing toward each other in said least one area, said coatings being the coating composed of a rubber mixture a resting on a paint composed of a rubber mixture and applied to the outer side of the first fabric layer of the spacing fabric and the inner coating composed of a rubber mixture and applied to the outer shell.

In yet another advantageous embodiment of the inflatable product according to the invention, the inflatable chamber comprises a space without a spacing fabric. According to the latter embodiment of the invention, the outer shell of the inflatable chamber is preferably provided with a separator for preventing the opposing inner walls of the shell from being mutually joined, said separator being arranged on the inner side of the shell where no spacing fabric is present.

In the case that the inflatable product according to the invention comprises at least two inflatable chambers, the latter are mutually joined in that the circumferential areas of the outer shells of individual chambers being partly interconnected by means of a vulcanized rubber mixture, as shown in FIGS. 9a and 9b. In the area of such a joint formed between two adjacent chambers, the individual chamber can be detached from each other, e.g., by cutting. When detached in the above manner, the inflatable chambers can be re-joined by applying a suitable adhesive, as shown in FIGS. 10a and 10b. The contact faces of the glued joints are provided with commercially available adhesives.

The structural arrangement of the vulcanized inflatable products according to the present invention provides a high level of protection against loss of airtightness which results in an increased reliability since the airtight layer is not arranged, unlike the technical solutions constituting the prior art, on the outer side of the inflatable chamber but on the inner side of the same, thus being protected by means of a firm fabric material, and since the products are provided with just a single circumferential joint composed of a vulcanized rubber mixture.

The sandwich structure of the products according to the present invention contributes to increased wear resistance, tear resistance and strength levels. When compared to the technical solutions, which constitute the prior art and which increase the mechanical resistance by employing thicker and/or additional foils or foam layers, the products according to the present invention are distinguished by superior packability and lower weight. Furthermore, the vulcanization of the paint and/or coating layers composed of a rubber mixture and situated in different areas of the product causes a the rubber molecules to be cross-linked in the course of a chemical reaction initiated by a vulcanizing system (vulcanizing agent+activator+accelerator). Thereby, a firm and compact link between the layers can be obtained. This is owing to the fact that a common layer of the vulcanised mixture is formed on each side of the spacing fabric, said common layer incorporating both the fabric layer of the spacing fabric and the carrying layer of the outer shell of the inflatable chamber. The properties of the above mentioned common layer can be influenced by the quality of the raw materials used, by the strength of the fabrics used and by the thicknesses of the coating/paint layers applied.

The structure of vulcanized inflatable products comprising spacing fabrics enables the intermediate spacing fabrics provided with paint and/or coating layers to be stacked on top of each other, thereby making it possible both to achieve greater mutual distance within the framework of a single confined inflatable chamber and to significantly eliminate forming of bulges on those surfaces of the product which should remain substantially planar when assuming the inflated state. The connecting threads of the spacing fabric, which are arranged inside the outer shell of the inflatable chamber, do not closely adjoin the connecting ribbon and the inner wall of the inner wall of the outer shell of the inflatable chamber, thereby enabling air to continuously flow into the free spaces between all pairs of the spacing fabrics which are firmly mutually joined by means of a vulcanized rubber mixture inside the inflatable chamber.

The carrying textile, which is provided with a coating layer composed of a rubber mixture and forming one of the walls of the outer shell, is unwound from a roll, which has been fed by a conveyor belt, and subsequently cut out a point where an inflation/deflation valve will be placed. Afterwards, the individual components of the inflatable chamber, i.e. the peripheral connecting ribbon, the spacing fabric and the internal partitions (I-beams), if any, are placed onto the inner adhesive layer composed of a rubber mixture and coated on the carrying fabric, each of said components being also provided by an adhesive coating composed of a rubber mixture. In addition, a separator can be applied to the surface areas where it is not desirable that the individual layers are mutually joined. Then, the wall of the outer shell, which carries the above components, is covered by the second carrying fabric, the latter being also provided by an adhesive coating composed of a rubber mixture, whereby the opposing wall of the outer shell is formed. Finally, the walls of the outer shell and the additional components arranged therebetween are pressed together by means of a pair of opposing rolls. The surplus overhanging portions of the outer shell are removed by cutting/shearing. After having been prepared in the above manner, the semi-finished products are vulcanized in a vulcanizing boiler (autoclave). After having been vulcanized in the above manner, the semi-finished products are fitted with inflation/deflation valves and with other components, such as various fixtures, handles or the like, the latter extending the scope of usability of the final products. Subsequently, the semi-finished products are assembled in various manners.

### BRIEF DESCRIPTION OF THE DRAWINGS

An exemplary embodiment of the invention is shown in the attached drawings, wherein

FIG. 1 shows a vulcanized inflatable product comprising a spacing fabric in a plan view,

FIG. 2 shows the same vulcanized inflatable product comprising a spacing fabric in a front elevation view,

FIG. 3 shows a section indicated as A-A in FIG. 1,

FIG. 4 shows the detailed structure of the spacing fabric provided with the paint and coating layers applied to the both sides thereof,

FIG. 5 shows the detailed structure of one portion of the shell of the inflatable chamber, said portion consisting of a carrying fabric provided with the paint and coating layers applied to the both sides thereof,

FIG. 6 shows a simplified structure of the portion of the inflatable chamber according to the Detail B indicated in FIG. 3,

FIG. 7 shows the vulcanized inflatable product in a plan view, wherein the spacing fabric does not cover the entire surface area of the inflatable chamber and the inflatable product is suitably supplemented with internal partitions arranged inside the free portion of the chamber,

FIG. 8 shows a multi-planar sectional view according to the indication in FIG. 7,

FIG. 9a shows a pair of chambers joined by means of a vulcanized rubber mixture,

FIG. 9b shows the detail D in a sectional view,

FIG. 10 shows an additional glued joint formed between the overhanging portions of two chambers,

FIG. 10b shows the detail E in a sectional view,

FIG. 11 shows a sectional view illustrating an inflatable product that comprises two spacing fabrics, the latter being stacked on top of each other.

### EXAMPLES OF PREFERRED EMBODIMENTS OF THE INVENTION

### Example 1

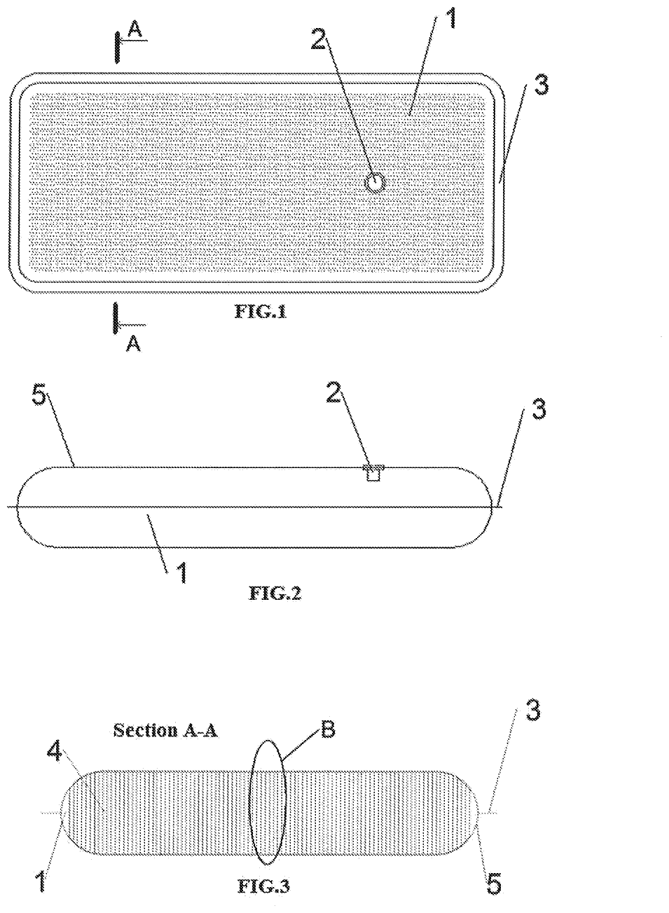

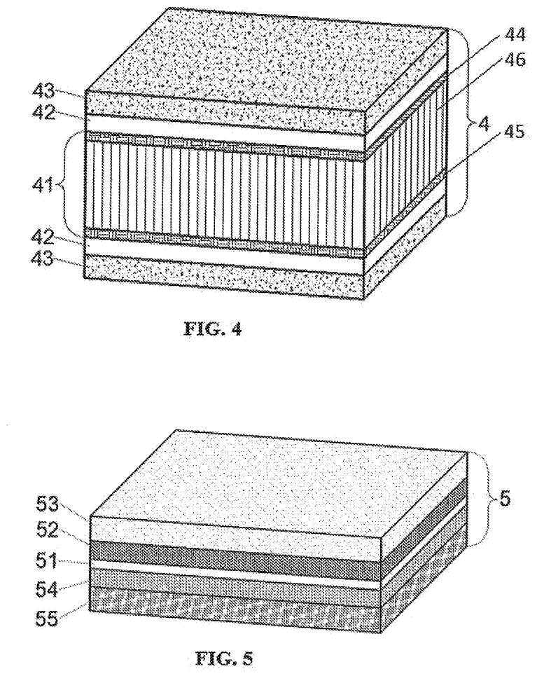

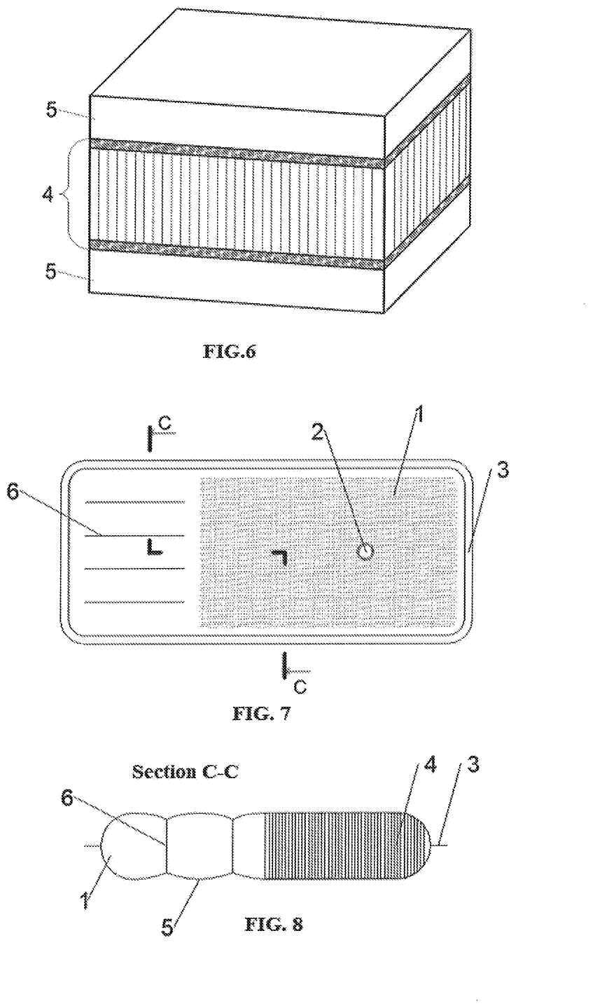

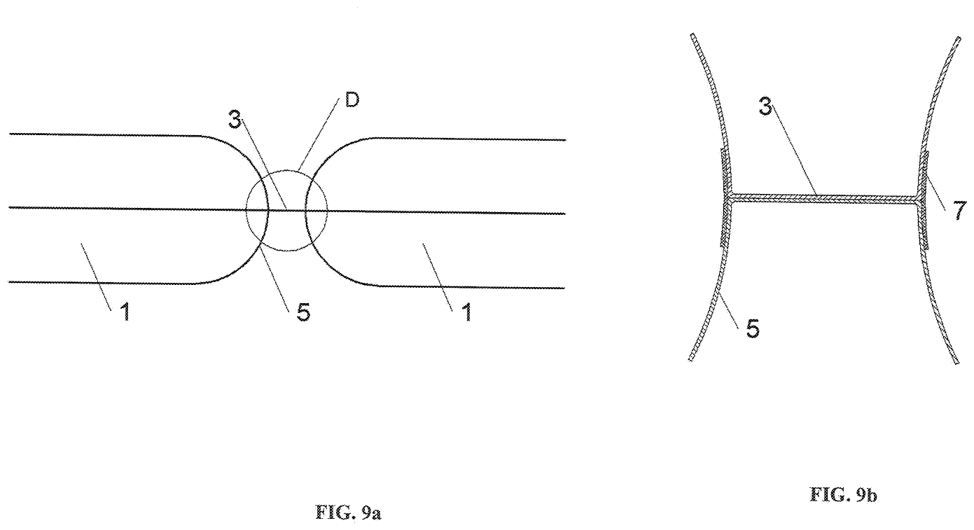

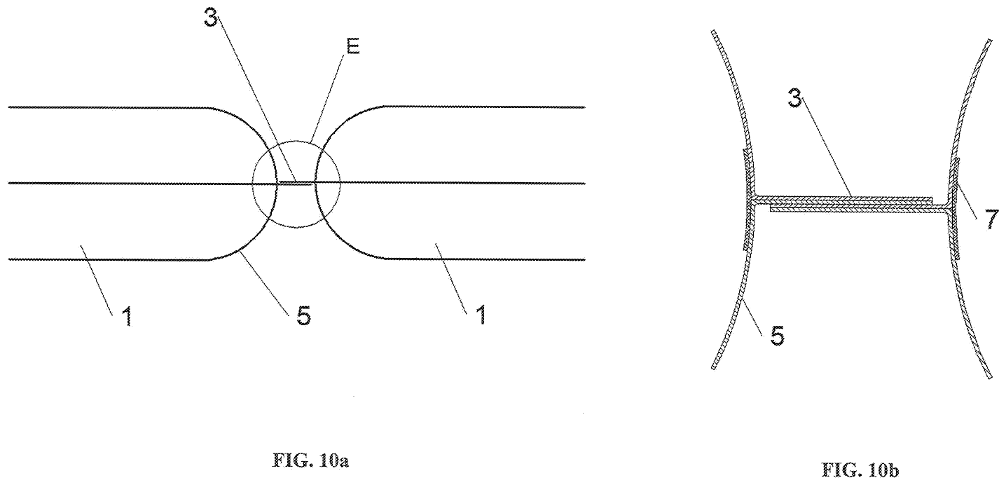

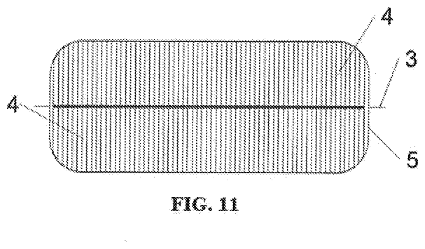

The vulcanized inflatable product comprising a spacing fabric, as shown in FIG. 1 to FIG. 6, is provided with the outer shell 5 comprising the carrying polyester fabric 51, the outer paint 52/outer coating 53 composed of a rubber mixture on the basis of NBR, sulphur in the amount of 2 phr, kaolin in the amount of 60 phr, ZnO in the amount of 4 phr, a phenolic antioxidant in the amount of 3 phr and a compound accelerator in the amount of 2 phr (represented by the mixture of 2,2-dibenzothiazyl sulphide, diphenylguanidine and 2-mercaptobenzthiazole, also referred to as MBT/MBRS/DPG), as well as the inner paint 54/inner coating 55 composed of a rubber mixture on the basis of the combination of NR and SBR in the weight ratio of 40:60, sulphur in the amount of 2.5 phr, kaolin in the amount of 65 phr, ZnO in the amount of 5 phr, a phenolic antioxidant in the amount of 3 phr and MBT/MBRS/DPG in the amount of 2 phr. The product comprises one inflatable chamber 1, in which a single-ply spacing element 4 in the form of a cut-out having the required shape, dimensions and (maximum) mutual distance between the outer surfaces of outer fabric layers totalling 67 mm is inserted using a build-up method, said spacing element consisting of an impregnated spacing fabric 41 comprising a pair of said fabric layers which are mutually tied up by means of interconnecting threads so as to cause the maximum thickness of the spacing fabric 41 to be delimited when the fabric layers are drawn apart in a distance corresponding to the fully tightened condition of the interconnecting threads. Both the fabric layers of the spacing fabric 41 are provided with a paint 42 and a coating 43 consisting of a rubber mixture, the paint and the coating being applied to the respective sides facing away from the interconnecting threads. In the course of the vulcanization process, a layer of the vulcanized rubber mixture is formed on each of the two opposing sides by joining the coating 43, 3, 55 and the paint 42, 52, 54 both the carrying layer 51 of the outer shell and the spacing fabric 41 being incorporated into the newly formed layer. According to the present exemplary embodiment, the spacing element 4 composed of the spacing fabric 41 substantially fills up the inner space of the inflatable chamber 1. This means than no internal partitions (or I-beams) 6 need to be provided. The inflatable chamber 1, which contains the spacing fabric element 4 inserted therein, is provided with a single joint 3 consisting of a vulcanized rubber mixture and extending along the circumference of the product, said joint being formed by the portions of the outer shell 5 extending beyond the spacing fabric a supplemented with the internal connecting ribbon 7. The inflatable product is provided with a single inflation and deflation valve 2.

### Example 2

The vulcanized inflatable product comprising a spacing fabric, as shown in FIG. 1 to FIG. 6, is provided with the outer shell 5 comprising the carrying polyester fabric 51I the outer paint 52/outer coating 53 as well as the inner paint 54/inner coating 55, said paints/coatings being composed of a rubber mixture on the basis of the combination of NR, SBR, EPDM, said mixture containing, per 100 parts (by weight) of the rubber combination having the overall weight ratio of 40:40:20, sulphur in the amount of 2.5 phr, kaolin in the amount of 55 phr, ZnO in the amount of 5 phr, a phenolic antioxidant in the amount of 3 phr and a compound accelerator in the amount of 3 phr (represented by the mixture of 2,2-dibenzothiazyl sulphide, diphenylguanidine and 2-mercaptobenzthiazole, also referred to as MBT/MBRS/DPG). The product comprises one inflatable chamber 1, in which a single-ply spacing element 4 in the form of a cut-out having the required shape, dimensions and (maximum) mutual distance between the outer surfaces of outer fabric layers totalling 100 mm is inserted using a build-up method, said spacing element consisting of an impregnated spacing fabric 41 comprising a pair of said fabric layers which are mutually tied up by means of interconnecting threads so as to cause the maximum thickness of the spacing fabric 41 to be delimited when the fabric layers are drawn apart in a distance corresponding to the fully tightened condition of the interconnecting threads. Both the fabric layers of the spacing fabric 41 are provided with a paint 42 and a coating 43 consisting of a rubber mixture, the paint and the coating being applied to the respective sides facing away from the interconnecting threads and the rubber mixture being identical to that used for the inner side of the carrying fabric layer of the outer shell 5. In the course of the vulcanization process, a layer of the vulcanized rubber mixture is formed on each of the two opposing sides by joining the coating 43, 53, 55 and the paint 42, 52, 54, both the carrying layer 51 of the outer shell and the spacing fabric 41 being incorporated into the newly formed layer. According to the present exemplary embodiment, the spacing element 4 composed of the spacing fabric 41 substantially fills up the inner space of the inflatable chamber 1. This means than no internal partitions (or I-beams) 6 need to be provided. The inflatable chamber 1, which contains the spacing fabric element 4 inserted therein, is provided with a single joint 3 consisting of a vulcanized rubber mixture and extending along the circumference of the product, said joint being formed by the portions of the outer shell 5 extending beyond the spacing fabric a supplemented with the internal connecting ribbon 7. The inflatable product is provided with a single inflation and deflation valve 2.

### Example 3

The vulcanized inflatable product comprising a spacing fabric, as shown in FIG. 1 to FIG. 6, is provided with the outer shell 5 comprising the carrying fabric 5 having the form of combined polyester/cotton fabric, the outer paint 52/outer coating 53 composed of polyurethane and the inner paint 54/inner coating 55 composed of a rubber mixture, the latter having the same composition as that described in Example 1. The product comprises one inflatable chamber 1, in which a single-ply spacing element 4 in the form of a cut-out having the required shape, dimensions and (maximum) mutual distance between the outer surfaces of outer fabric layers totalling 150 mm is inserted using a build-up method, said spacing element consisting of an impregnated spacing fabric 41 comprising a pair of said fabric layers which are mutually tied up by means of interconnecting threads so as to cause the maximum thickness of the spacing fabric 41 to be delimited when the fabric layers are drawn apart in a distance corresponding to the fully tightened condition of the interconnecting threads. Both the fabric layers of the spacing fabric 41 are provided with a paint 42 and a coating 43 consisting of a rubber mixture, the paint and the coating being applied to the respective sides facing away from the interconnecting threads and the rubber mixture being identical to that used for the inner side of the carrying fabric layer of the outer shell 5. In the course of the vulcanization process, a layer of the vulcanized rubber mixture is formed on each of the two opposing sides by joining the coating 43, 55 and the paint 42, 54, both the carrying layer 51 of the outer shell and the spacing fabric 41 being incorporated into the newly formed layer. According to the present exemplary embodiment, the spacing element 4 composed of the spacing fabric 41 substantially fills up the inner space of the intlatable chamber 1. This means than no internal partitions (or I-beams) 6 need to be provided. The inflatable chamber 1, which contains the spacing element 4 inserted therein, is provided with a single joint 3 consisting of a vulcanized rubber mixture and extending along the circumference of the product, said joint being formed by the portions of the outer shell 5 extending beyond the spacing fabric a supplemented with the internal connecting ribbon 7. The inflatable product is provided with a single inflation and deflation valve 2.

### Example 4

The vulcanized inflatable product comprising a spacing fabric, as shown in FIG. 7 to FIG. 8, is provided with the outer shell 5 comprising the carrying polyester fabric 51, the outer paint 52/outer coating 53 composed of a rubber mixture on the basis of CR and CSM contained in the weight ratio of 25:75 and supplemented with MgO in the amount of 3.5 phr, kaolin in the amount of 60 phr, a mineral oil in the amount of 25 phr and an accelerator (dipentamethylenethiuram tetrasulphide, DPTT) in the amount of 2 phr, and the inner paint 54/inner coating 55 composed of a rubber mixture, the latter having the same composition as that described in Example 1. The product comprises one inflatable chamber 1, in which a single-ply spacing element 4 in the form of a cut-out having the required shape, dimensions and mutual distance between the fabric layers totalling 100 mm is inserted using a build-up method, said spacing element consisting of an impregnated spacing fabric 41 comprising a pair of said fabric layers which are mutually tied up by means of interconnecting threads so as to cause the maximum thickness of the spacing fabric 41 to be delimited when the fabric layers are drawn apart in a distance corresponding to the fully tightened condition of the interconnecting threads. Both the fabric layers of the spacing fabric 41 are provided with a paint 42 and a coating 43 consisting of a rubber mixture, the paint and the coating being applied to the respective sides facing away from the interconnecting threads and the rubber mixture being identical to that used for the inner side of the carrying fabric layer of the outer shell 5. In the course of the vulcanization process, a layer of the vulcanized rubber mixture is formed on each of the two opposing sides by joining the coating 43, 53, 55 and the paint 4, 52, 4, both the carrying layer 51 of the outer shell and the spacing fabric 41 being incorporated into the newly formed layer. In this exemplary embodiment, the spacing element 4 composed of the spacing fabric 41 does not entirely fill up the inner space of the inflatable chamber 1. The portion of the inflatable chamber, which does not contain the spacing element 4 protruding thereto, is further provided with the internal partitions (I-beams) 6 made of a polyester fabric and inserted therein, said partitions having suitable heights and being provided with a coating or paint composed of a rubber mixture applied both to the outer side and to the inner side thereof. Moreover, said partitions are arranged between the top and bottom portions of the outer shell 5. The inner side of the outer shell is provided with a paint layer on the basis of CaCO₃, said layer being applied to the surface area, which is not adjoined by the spacing fabric or the internal partition, and serving as a separator. The inflatable chamber 1, which contains the spacing element 4 inserted therein, is provided with a single joint 3 consisting of a vulcanized rubber mixture and extending along the circumference of the product, said joint being formed by the portions of the outer shell 5 extending beyond the spacing fabric a supplemented with the internal connecting ribbon 7. The inflatable product is provided with a single inflation and deflation valve 2.

### Example 5

The vulcanized inflatable product comprising a spacing fabric, as shown in FIG. 1 to FIG. 6, is provided with the outer shell 5 comprising the carrying polyester fabric 51, the outer paint 52/outer coating 53 composed of a rubber mixture and the inner paint 54/inner coating 55 composed of a rubber mixture, said rubber mixtures having the same compositions as those described in Example 1. The product comprises one inflatable chamber 1, in which spacing elements 4 in the form of a cut-outs having the required shapes, dimensions and (maximum) mutual distance between the outer surfaces of outer fabric layers totalling 67 mm is inserted in a double-ply manner using a build-up method, said spacing element consisting of an impregnated spacing fabric 41 comprising a pair of said fabric layers which are mutually tied up by means of interconnecting threads so as to cause the maximum thickness of the spacing fabric 41 to be delimited when the fabric layers are drawn apart in a distance corresponding to the fully tightened condition of the interconnecting threads. Both the fabric layers of each the pairs of spacing fabrics 41 are provided with the paint 42 and a coating 43 consisting of a rubber mixture, the paint and the coating being applied to the respective sides facing away from the interconnecting threads and the rubber mixture having the same composition as that described in Example 1. In the course of the vulcanization process, a layer of the vulcanized rubber mixture is formed on each of the two opposing sides by joining the coating 43, 53, 55 and the paint 42, 52, 54, both the carrying layer 51 of the outer shell and the spacing fabric 41 being incorporated into the newly formed layer. In this exemplary embodiment, the spacing elements 4 formed by the spacing fabric 41 substantially fill up the inner space of the inflatable chamber 1. This means than no internal partitions (or I-beams) 6 need to be provided. The inflatable chamber 1, which contains the spacing fabric element 4 inserted therein, is provided with a single joint 3 consisting of a vulcanized rubber mixture and extending along the circumference of the product, said joint being formed by the portions of the outer shell 5 extending beyond the spacing fabric a supplemented with the internal connecting ribbon 7. The inflatable product is provided with a single inflation and deflation valve 2.

### Example 6

In still another exemplary embodiment of the inflatable product according to the invention, which is not illustrated in the drawings, at least a certain portion of the coating 43 composed of a rubber mixture resting on the paint 42 composed of a rubber mixture applied to the outer side of the first fabric layer 44 of the spacing fabric 41 and/or at least a certain portion of the coating 43 composed of a rubber mixture resting on the paint 42 composed of a rubber mixture applied to the outer side of the second fabric layer 45 of the spacing fabric 41 is provided with a separator preventing said portions from being mutually joined or from being joined with any partial area of the inner wall of the outer shell 5 of the inflatable chamber 1 in a direct or indirect manner. Alternatively, at least one portion of the inner coating 5, which has been applied to the inner wall of the outer shell 5, can be provided with a separator. After having been inflated, the product contains a spatial arrangement formed inside it, those portions of the spacing fabric 41, which have their fabric layers 44, 45 attached to the respective inner wall of the outer shell 5 of the inflatable chamber 1, delimit the height of the inflated inner space through their connecting threads 46. Nevertheless, the inflatable chamber 1 can become bulged between the above mentioned portion and/or portions of the first fabric layer 44 provided with the separator and/or the second fabric layer 45 of the spacing fabric 41 on the one hand and the corresponding portion of the inner wall of the outer shell 5 of the inflatable chamber 1 and/or the corresponding portions of the inner walls of the outer shell 5 of the inflatable chamber 1 on the other hand, thereby causing said corresponding portion of the wall and/or portions of the walls of the outer shell 5 to project beyond the level defined by those portions of the walls of the outer shell 5 which adjoin the fabric layers 44, 45 of the spacing fabric 41.

### Example 7

In a still further exemplary embodiment of the inflatable product according to the present invention, which embodiment is not shown in the drawings, the inner space of the inflatable chamber 1 is not entirely filled up with the spacing fabric 41. The remaining portion of the inner space of the inflatable chamber 1 is empty, the inner walls of the outer shell 5 of the inflatable chamber 1 surrounding said remaining portion of the inner space of the inflatable chamber 1 being provider by a separator for preventing the opposing wall of the outer shell 5 from being mutually joined. After the product has been inflated, the inner space of the inflatable chamber is filled up with air, the walls of the outer shell 5 carrying the fabric layers 44, 45 of the spacing fabric 41 being limited in terms of their maximum achievable mutual spacing, said limitation being realized by means of the connecting threads 46, while those walls of the outer shell 5, which surround the remaining portion of the inner space of the inflatable chamber 1, i.e. the portion without the spacing fabric 41, are not limited in such a manner, thus forming a bulge.

Needless to say, the above exemplary embodiments of the vulcanized inflatable products comprising spacing fabric cannot be considered to be exhaustive. In addition to polyester materials, multiple other types of fabric materials are usable for preparing the carrying fabric, the spacing fabric and the internal partitions (I-beams), regardless of whether natural materials, such as cotton or viscose, or synthetic ones, such as polyamide or polypropylene, are concerned. The only prerequisite consists in that such fabric materials must be suitable for being provided with paint and/or coating layers. Similarly, other suitable paint or coating materials than rubber mixtures can be used for the outer side of the carrying fabric of the outer shell, such materials including polyurethanes, polyvinyl chloride or the like. Alternatively, the provision of the outer shell with a paint or coating layer can be completely omitted. The paint or coating layers can be applied to the surface of the carrying fabrics, spacing fabrics and internal partitions (I-beams) in multiple numbers and orders, the above examples being not exhaustive in this regard. The spacing fabric can be a woven or knitted one having various parameters, such as thickness, bond, specific weight, type of yarn used, quantities of fibres, numerousness of knots and way of interlacing (e.g., when using hair-like velour threads). In addition, the maximum mutual distance of the fabric layers of the spacing fabric can be varied as required. The arrangement and number of the internal partitions (I-beams), as well as the variable height of the same, can be utilized for influencing the final shape of the product. When the spacing fabrics having equal or different mutual distances are stacked in multiple layers, various final arrangements of the product can be obtained.

### INDUSTRIAL APPLICABILITY

The vulcanized inflatable products comprising spacing fabrics according to the present invention are usable for the manufacture of inflatable boats, camp beds, mattresses, flood protection barriers, sports ground, tent floorings, rescue chutes, rescue gangways, floating wharfs and piers, pontoons, rescue litters, props, mobile partitions, pools, paddle boards, etc., when there is a need of improved mechanical properties, higher level of protection against loss of airtightness and improved efficiency of the final assembly process.

1-14. (canceled)

15. A vulcanized inflatable product comprising an impervious shell which forms walls of at least one inflatable chamber and which is provided with a valve for inflating and deflating the inflatable product, wherein at least one spacing fabric is arranged inside the inflatable chamber, said spacing fabric comprising a first fabric layer and a second fabric layer mutually tied up by means of interconnecting threads for delimiting a maximum distance therebetween, the first fabric layer of the spacing fabric being directly or indirectly secured to an inner side of the shell, which forms the inflatable chamber, by means of a vulcanized rubber mixture, and the other fabric layer of the spacing fabric being directly or indirectly secured to an opposite inner side of the shell, which forms the inflatable chamber, by means of a vulcanized rubber mixture.

16. The inflatable product according to claim 15, wherein the outer shell of the inflatable chamber comprises at least one carrying fabric, said carrying fabric and the fabric layers of the spacing fabric being embedded, in a mutually adjacent arrangement, within a common layer of a vulcanized rubber mixture.

17. The inflatable product according to claim 15, wherein the spacing fabric has a circumference and the outer shell of the inflatable chamber comprises a first portion and a second portion, which extend beyond the spacing fabric along the circumference thereof, thus enabling formation of a common circumferential joint between said portions to create the inflatable chamber, the common circumferential joint being formed by means of a vulcanized rubber mixture.

18. The inflatable product according to claim 16, wherein the carrying fabric is provided with a paint and/or coating applied to its outer side, said paint and/or coating being composed of a material selected from a group consisting of a vulcanized rubber mixture, polyurethane and polyvinyl chloride.

19. The inflatable product according to claim 18, wherein the carrying fabric of the outer shell is selected from a group consisting of a polyester fabric, a cotton fabric, a viscose fabric, a polyamide fabric, a polypropylene fabric, and any combination thereof.

20. The inflatable product according to claim 15, wherein the inflatable chamber comprises at least one fabric partition, which is joined with the outer shell by means of a vulcanized rubber mixture.

21. The inflatable product according to claim 17, wherein the common circumferential joint, which is formed between the first portion and the second portion, is at least partially covered by an internal connecting ribbon, which is arranged inside the inflatable chamber and secured to the outer shell by means of a vulcanized rubber mixture.

22. The inflatable product according to claim 17, further comprising a set of at least two inflatable chambers, the circumferential areas of the outer shells of the individual chambers being partially interconnected by means of a vulcanized rubber mixture.

23. The inflatable product according to claim 22, wherein the joint formed between the first portion and the second portion of a first of the inflatable chambers and the joint formed between the first portion and the second portion of a second of the inflatable chambers, which adjoins the first inflatable chamber, are incorporated in an interconnecting area of said mutually adjoining inflatable chambers.

24. The inflatable product according to claim 15, wherein the fabric layers of the spacing fabric are secured to the walls of the inflatable chamber in an area-wide manner.

25. The inflatable product according to claim 15, wherein:
the first fabric layer of the spacing fabric is provided at its outer side with a paint of a rubber mixture and thereon with a coating of a rubber mixture,
the outer shell is provided with an inner coating of a rubber mixture,
wherein the inflatable product further comprises a separator for preventing the coatings from being mutually joined in at least one area, said separator being arranged between the coatings which face each other in said at least one area.

26. The inflatable product according to claim 15, wherein the inflatable chamber comprises a space without the spacing fabric.

27. The inflatable product according to claim 26, wherein the outer shell of the inflatable chamber is provided with a separator for preventing opposing inner walls of the shell from being mutually joined, said separator being arranged on the inner side of the shell where no spacing fabric is present.

28. The inflatable product according to claim 15, characterized in that the first fabric layer and the second fabric layer are mutually tied up by means of auxiliary threads for fixing the fabric layers in a mutual position, in which the fabric layers adjoin each other prior to an initial inflation of the inflatable product.
